(19) United States
(12) Patent Application Publication
(10) Pub. No.: US 2020/0300239 A1
(43) Pub. Date: Sep. 24, 2020

(54) HAND AIR PUMP INFLATING DEVICE

(71) Applicant: BETO ENGINEERING AND MARKETING CO., LTD., Taichung City (TW)

(72) Inventor: Lopin WANG, Taichung City (TW)

(21) Appl. No.: 16/794,706

(22) Filed: Feb. 19, 2020

(30) Foreign Application Priority Data
Mar. 20, 2019 (TW) 108109597

(51) Int. Cl. F04B 53/14

(52) U.S. Cl. CPC F04B 53/148; F16K 15/18; F04B 53/146; F04B 53/143

(57) ABSTRACT

A hand air pump inflating device includes a cylinder body, a tubular shaft and a tubular piston rod extending longitudinally, larger and smaller end caps respectively enclosing rear ends of the piston rod and the cylinder body, front and rear piston ring modules respectively enclosing a front end of the piston rod and a rear end of the tubular shaft, and a one-way check valve disposed between the rear end of the tubular shaft and the rear piston ring module. The piston rod is movable forward and rearward relative to the cylinder body and the tubular shaft for inflating an inflatable object.

### CROSS-REFERENCE TO RELATED APPLICATION

This application claims priority of Taiwanese Patent Application No. 108109597, filed on Mar. 20, 2019.

### FIELD

The disclosure relates to an air pump inflating device, and more particularly to a hand air pump inflating device.

### BACKGROUND

A conventional hand air pump inflator for a racing bicycle, such as that disclosed in CN 101737294, generally includes an inner tube which is fixed to a nozzle at a front end, and an outer tube which is sleeved around the inner tube and displaceable relative to the inner tube for pumping air to the nozzle. A user grips and holds the inner tube with one hand, and pulls and pushes the outer tube with the other hand relative to the inner tube. The movement of the outer tube is interfered by the hand gripping the inner tube, which results in inconvenience during operation, and which limits a forward stroke of the outer tube and an inflating efficiency of the inflator.

### SUMMARY

Therefore, an object of the disclosure is to provide a hand air pump inflating device that can alleviate at least one of the drawbacks of the prior art.

According to the disclosure, the hand air pump inflating device includes a nozzle and a cylinder mechanism. The nozzle has an inflating conduit formed therein. The cylinder mechanism includes a cylinder body, a tubular shaft, a tubular piston rod, a larger end cap, a smaller end cap, a front piston ring module, a rear piston ring module and a one-way check valve. The cylinder body extends in a longitudinal direction to terminate at opened front and rear cylinder ends. The front cylinder end is fixed to the nozzle. The tubular shaft is disposed within the cylinder body and extends in the longitudinal direction to terminate at opened front and rear shaft ends. The front shaft end is fixed to the nozzle and in air communication with the inflating conduit. The tubular piston rod is movably disposed within the cylinder body, surrounds the tubular shaft, and extends in the longitudinal direction to terminate at opened front and rear piston ends, such that the tubular piston rod is movable relative to the cylinder body and the tubular shaft in the longitudinal direction to reciprocate a rearward stroke and a forward stroke. The larger end cap is disposed on and encloses the rear piston end. The smaller end cap is disposed on and encloses the rear cylinder end and is sleeved on and in air-tight and movable engagement with the tubular piston rod. The front piston ring module is disposed on and encloses the front piston end, and has an outer ring portion which is in frictional engagement with the cylinder body to divide a space between the cylinder body and the piston rod into first and second chambers respectively close to the front and rear cylinder ends, and an inner ring portion which is sleeved on and in air-tight and movable engagement with the tubular shaft, such that the front piston ring module is moved with the tubular piston rod to interrupt air communication between the first and second chambers by the rearward stroke, and to permit the air communication between the first and second chambers by the forward stroke. The rear piston ring module is disposed on and encloses the rear shaft end, and is in movable and frictional engagement with the tubular piston rod to divide a space between the tubular piston rod and the tubular shaft into third and fourth chambers respectively close to the front and rear piston ends, such that the rear piston ring module is moved relative to the tubular piston rod to permit air communication between the third and fourth chambers by the rearward stroke, and to interrupt the air communication between the third and fourth chambers by the forward stroke. The check valve is disposed between the rear shaft end of the tubular shaft and the rear piston ring module to only permit passage of air from the fourth chamber to the tubular shaft. During the rearward stroke, a negative pressure is generated in the first chamber as a result of volume increment to introduce air thereinto, and air in the second chamber is pressed into the third chamber and the fourth chamber.

During the forward stroke, air in the first chamber is pressed to flow into the second chamber and the third chamber, a positive pressure is generated in the fourth chamber as a result of volume decrement to open the check valve, and air in the fourth chamber is pressed to flow into the tubular shaft.

### BRIEF DESCRIPTION OF THE DRAWINGS

Other features and advantages of the disclosure will become apparent in the following detailed description of the embodiment with reference to the accompanying drawings, of which:

FIG. 1 is a perspective view illustrating an embodiment of a hand air pump inflating device according to the disclosure;

FIG. 2 is an exploded perspective view of the embodiment;

FIG. 3 is a sectional view of the embodiment;

FIG. 4 is a sectional view illustrating a state when a tubular piston rod of the embodiment is pulled by a rearward stroke;

FIG. 5 is a fragmentary, enlarged sectional view of FIG. 4;

FIG. 6 is a sectional view illustrating a state when the tubular piston rod is pushed by a forward stroke; and

FIG. 7 is a fragmentary, enlarged sectional view of FIG. 6.

### DETAILED DESCRIPTION

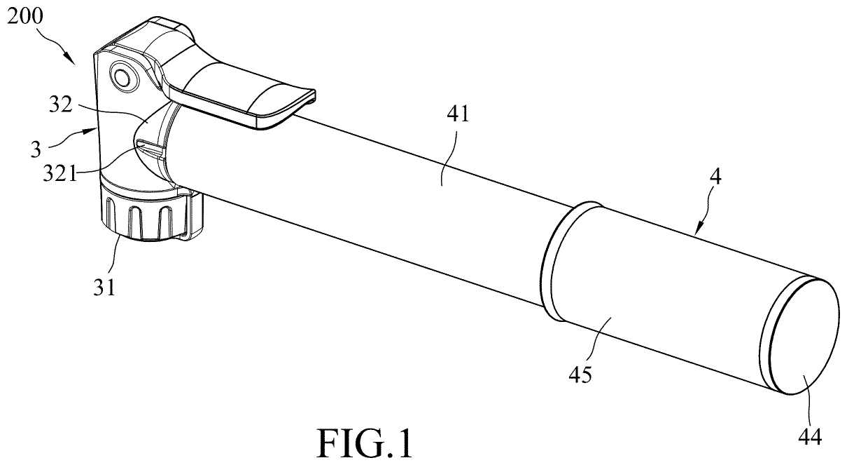

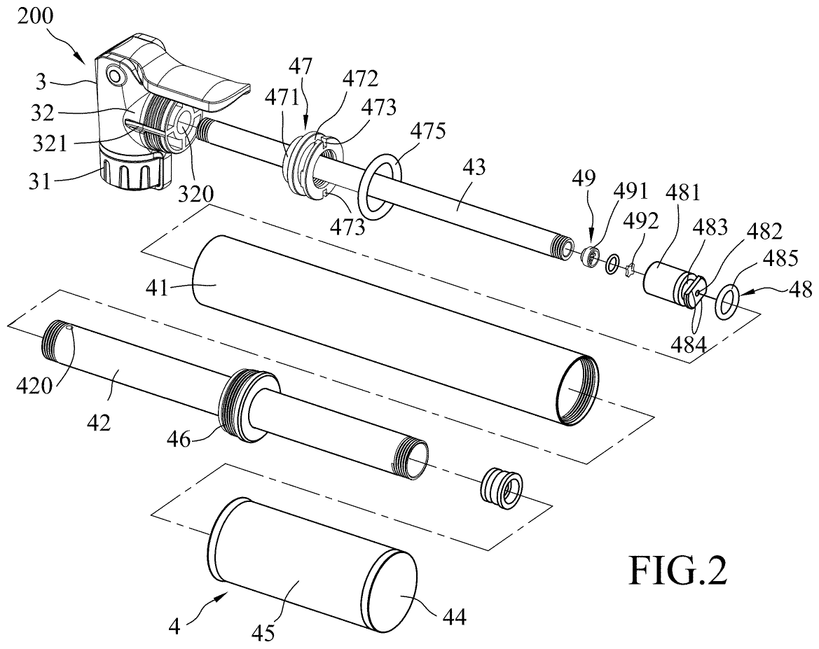

Referring to FIGS. 1 and 2, an embodiment of a hand air pump inflating device 200 according to the disclosure is adapted to be coupled with an inflatable object (not shown), such as a bicycle tire, a ball, etc., and includes a nozzle 3 for the inflatable object to be coupled therewith, and a cylinder mechanism 4 securely mounted to the nozzle 3.

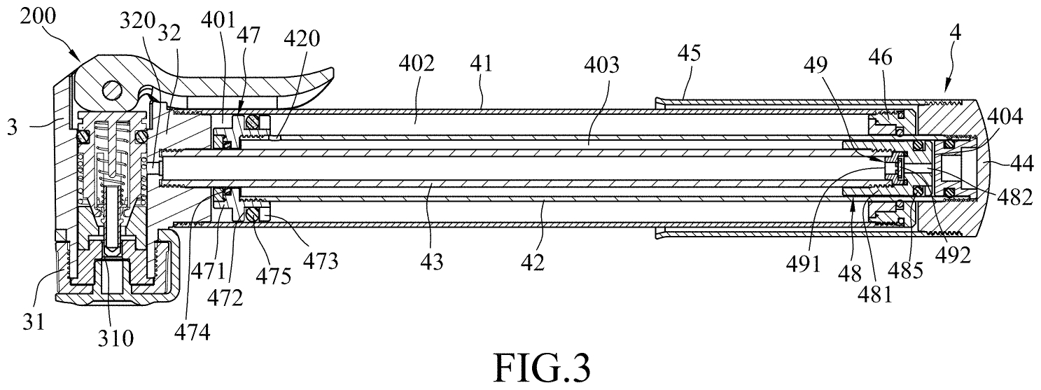

Referring to FIG. 3, the nozzle 3 has an object coupling portion 31 which is coupled with the inflatable object and which has an inflating port 310, and a cylinder coupling portion 32 which is connected with the cylinder mechanism 4. The cylinder coupling portion 32 has an inflating conduit 320 formed therethrough and extending in a longitudinal direction to be in air communication with the inflating port 310, and an intake slot 321 formed in an outer surrounding surface thereof and extending in the longitudinal direction.

Referring to FIGS. 2 to 4, the cylinder mechanism 4 includes a cylinder body 41, a tubular shaft 43 and a tubular piston rod 42 each extending in the longitudinal direction to terminate at front and rear cylinder, shaft, or piston ends. The front cylinder end of the cylinder body 41 is fixed to the cylinder coupling portion 32 of the nozzle 3 to cooperatively define the intake slot 321 in air communication with the cylinder body 41 and ambient air. The tubular shaft 43 is disposed within the cylinder body 41 to have the front shaft end fixed to the cylinder coupling portion 32 of the nozzle 3 and in air communication with the inflating conduit 320. The tubular piston rod 42 is movably disposed within the cylinder body 41, and surrounds the tubular shaft 43 such that the tubular piston rod 42 is movable relative to the cylinder body 41 and the tubular shaft 43 in the longitudinal direction to reciprocate a rearward stroke and a forward stroke.

The cylinder mechanism 4 further includes a larger end cap 44 which is securely disposed on and encloses the rear piston end of the tubular piston rod 42, a tubular handgrip 45 which is securely connected with the larger end cap 44 and has a grip wall extending forwardly to surround the rear cylinder end of the cylinder body 41, a smaller end cap 46 which is securely disposed on and encloses the rear cylinder end of the cylinder body 41 and is sleeved on and in air-tight and movable engagement with the tubular piston rod 42, a front piston ring module 47 which is securely disposed on and encloses the front piston end of the tubular piston rod 42 and is interposed between the cylinder body 41 and the tubular shaft 43, a rear piston ring module 48 which is securely disposed on and encloses the rear shaft end of the tubular shaft 43 and is frictionally disposed within the tubular piston rod 42, and a one-way check valve 49 which is disposed between the rear shaft end of the tubular shaft 43 and the rear piston ring module 48.

Since the structures of the larger end cap 44 and the smaller end cap 46 may be varied and of a hitherto known type, a description thereof is dispensed with herein for the sake of brevity.

Specifically, the front piston ring module 47 has an outer ring portion which is in frictional engagement with the cylinder body 41 to divide a space between the cylinder body 41 and the piston rod 42 into first and second chambers 401, 402 respectively close to the front and rear cylinder ends of the cylinder body 41, and an inner ring portion which is sleeved on and in air-tight and movable engagement with the tubular shaft 43. The first chamber 401 is in air communication with the intake slot 321 for introducing air thereinto. In this embodiment, the front piston ring module 47 includes a front piston ring body 471 which is securely connected with the front piston end of the tubular piston rod 42, and which has an outer annular groove 472 formed in an outer surrounding surface thereof, and a plurality of notched passages 473 extending in the longitudinal direction to be in air communication with the outer annular groove 472 and the second chamber 402, a fixed seal ring 474 which is securely disposed on an inner surrounding surface of the front piston ring body 471 to serve as the inner ring portion, and a movable seal ring 475 which is received in the outer annular groove 472 to serve as the outer ring portion.

Referring to FIGS. 3 to 5, during the rearward stroke of the tubular piston rod 42, the front piston ring module is moved rearward with the tubular piston rod 42 relative to the cylinder body 41 such that the movable seal ring 475 is slightly displaced forwards relative to the front piston ring body 471 due to frictional contact with an inner surrounding surface of the cylinder body 41 so as to seal the clearance between the front piston ring body 471 and the cylinder body 41 to interrupt the air communication between the first and second chambers 401, 402.

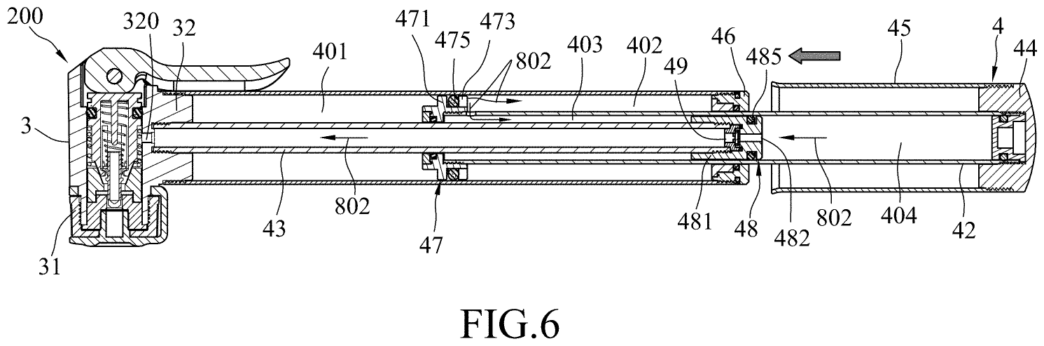

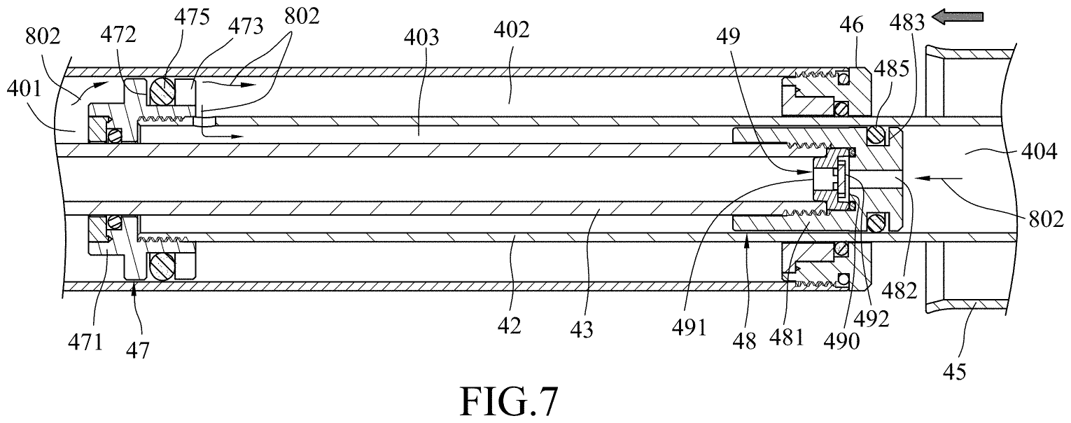

Referring to FIGS. 6 and 7, on the contrary, during the forward stroke of the tubular piston rod 42, the front piston ring module 47 is moved forward with the tubular piston rod 42 relative to the cylinder body 41 such that the movable seal ring 475 is slightly displaced rearwards relative to the front piston ring body 471 due to frictional contact with the inner surrounding surface of the cylinder body 41 so as to permit air communication of the outer annular groove 472 with the first chamber 401, and with the second chamber 402 through the notched passages 473 to make the air communication between the first chamber 401 and the second chamber 402.

Referring to FIGS. 2 to 5, the rear piston ring module 48 is in movable and frictional engagement with an inner surrounding surface of the tubular piston rod 42 to divide a space between the tubular piston rod 42 and the tubular shaft 43 into third and fourth chambers 403, 404 respectively close to the front and rear piston ends. Also, the tubular piston rod 42 has an aperture 420 which is formed at the front piston end and extends radially to be in air communication with the second chamber 402 and the third chamber 403. The rear piston ring module 48 includes a rear piston ring body 481 which is securely connected with the rear shaft end of the tubular shaft 43, and which has an axial hole 482 in air communication with the fourth chamber 404 and the tubular shaft 43, an outer annular groove 483 formed in an outer surrounding surface thereof, and two diametrically opposite notched passages 484 extending in the longitudinal direction to be in air communication with the outer annular groove 483 and the fourth chamber 404. The rear piston ring module 48 further includes a movable seal ring 485 which is received in the outer annular groove 483 and in air-tight abutment against the inner surrounding surface of the tubular piston rod 42.

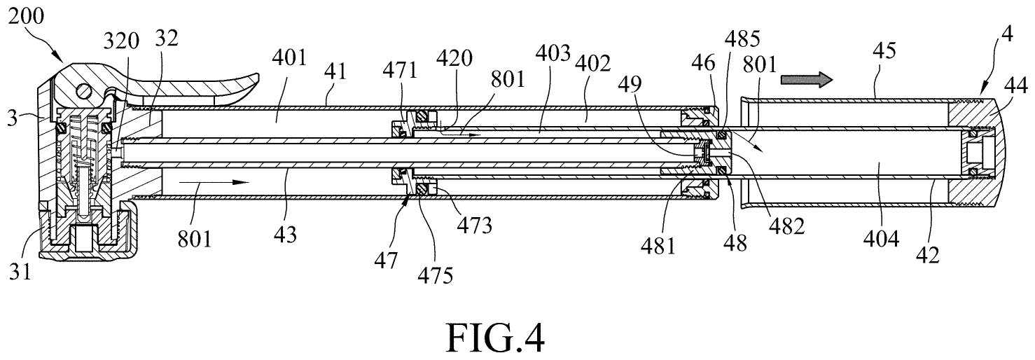

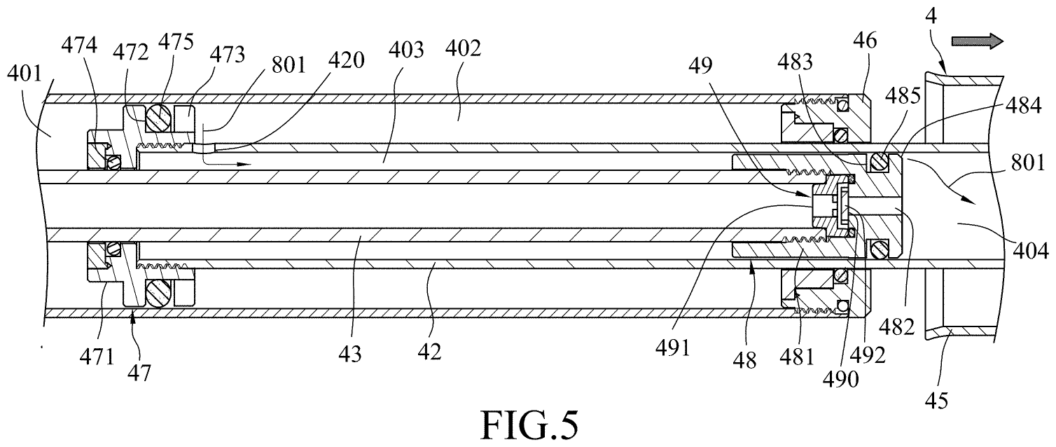

Referring to FIGS. 4 and 5, during the rearward stroke of the tubular piston rod 42, i.e., when the rear piston ring module 48 is moved forward relative to the tubular piston rod 42, the movable seal ring 485 is slightly displaced rearwards relative to the rear piston ring body 481 due to frictional contact with the inner surrounding surface of the tubular piston rod 42 to permit air communication of the outer annular groove 483 with the third chamber 403. The outer annular groove 483 is in air communication with the fourth chamber 404 through the notched passages 484 (see FIG. 2) so that the third chamber 403 is in air communication with the fourth chamber 404.

Referring to FIGS. 6 and 7, on the contrary, during the forward stroke of the tubular piston rod 42, i.e., when the rear piston ring module 48 is moved rearward relative to the tubular piston rod 42, the movable seal ring 485 is slightly displaced forwards relative to the rear piston ring body 481 due to frictional contact with the inner surrounding surface of the tubular piston rod 42 so as to seal the clearance between the rear piston ring body 481 and the inner surrounding surface of the tubular piston rod 42 to interrupt the air communication between the third and fourth chambers 403, 404.

Referring to FIGS. 2, 5 and 7, the check valve 49 includes a valve seat 490 which is formed in an end of the axial hole 482 of the rear piston ring body 481, a valve disc 492 which is movably disposed between the valve seat 490 and the rear shaft end of the tubular shaft 43 in the longitudinal direction, and an annular valve housing 491 which is securely connected with the rear shaft end of the tubular shaft 43 and at a side of the valve disc 492 opposite to the valve seat 490 for receiving the valve disc 492 and limiting a forward movement of the valve disc 492. The valve disc 492 is pressed to abut against and close the valve seat 490 by a pressure in the tubular shaft 43 which is larger than that in the fourth chamber 404 (see FIG. 5), and to be away from the valve seat 490 by a pressure in the fourth chamber 404 which is larger than that in the tubular shaft 43 so as to permit passage of air from the fourth chamber 404 to the tubular shaft 43 (see FIG. 7).

During the manual operation of the inflating device 200, the nozzle 3 is coupled to an inflatable object. The user grips the front cylinder end of the cylinder body 41 with one hand, and the tubular handgrip 45 with the other hand to pull and push the tubular handgrip 45 and the tubular piston rod 42 relative to the cylinder body 41 so as to make rearward and forward strokes.

With reference to FIGS. 3 to 5, during the rearward stroke of the tubular piston rod 42, i.e., when the cylinder mechanism 4 is stretched, a negative pressure is generated in the first chamber 401 as a result of volume increment to introduce air thereinto from the intake slot 321 (see FIG. 2), as indicated by the arrow 801 of FIGS. 4 and 5, and air in the second chamber 402 is pressed, as a result of volume decrement, into the third chamber 403 and the fourth chamber 404, as indicated by the arrow 801 of FIGS. 4 and 5. The rearward stroke is limited when the front piston ring module 47 abuts against the smaller end cap 46.

Subsequently, the tubular handgrip 45 is pushed forward relative to the cylinder body 41 to retract the tubular piston rod 42 forward into the cylinder body 41, i.e., the cylinder mechanism 4 is retracted until the larger end cap 44 abuts against the smaller end cap 46, as shown in FIG. 3.

With reference to FIGS. 6 and 7, during the forward stroke of the tubular piston rod 42, the front piston ring module 47 is moved to permit air communication between the first and second chambers 401, 402. Air in the first chamber 401 is pressed, as a result of volume decrement in the first chamber 401, to flow into the second chamber 402 and then into the third chamber 403, as indicated by the arrow 802 of FIGS. 6 and 7. On the other hand, the rear piston ring module 48 is moved to interrupt the air communication between the third and fourth chambers 403, 404. A positive pressure is generated in the fourth chamber 404 as a result of volume decrement to open the check valve 49 and air in the fourth chamber 404 is pressed to flow into the tubular shaft 43 through the axial hole 482, as indicated by the arrow 802 of FIGS. 6 and 7. The air in the tubular shaft 43 further moves into the inflatable object through the nozzle 3.

In this embodiment, the first chamber 401 in the cylinder body 41 is in air communication with the ambient air through the intake slot 321 formed in the outer surrounding surface of the cylinder coupling portion 32 of the nozzle 3 and defined by the fitting coupling of the cylinder coupling portion 32 with the front cylinder end of the cylinder body 41. Alternatively, the intake slot 321 may be recessed in the inner surrounding surface of the cylinder body 41. The intake slot 321 may be in the form of a penetrating hole formed through the cylinder body 41 to be in air communication with the first chamber 401. Moreover, the check valve 49 may be alternatively in other various forms.

Furthermore, the tubular handgrip 45 of this embodiment may be dispensed therewith. In such case, the tubular piston rod 42 may be formed to further project rearwardly to form as a handgrip portion. Hence, the manual operation of the tubular piston rod 42 is convenient to conduct without interfering by the hand gripping the nozzle 3 or the cylinder body 41.

As illustrated, with the cylinder body 41 secured to the nozzle 3 and the tubular shaft 43 disposed within the tubular piston rod 42 and secured to the nozzle 3, the tubular piston rod 42 is movable relative to the cylinder body 41 and the tubular shaft 43 to reciprocate rearward and forward strokes, and the hands of the user can individually grip the nozzle 3 or the cylinder body 41, and the rear piston end of the tubular piston rod 42 without interfering each other. Further, the tubular piston rod can be moved forward sufficiently to improve the inflating efficiency. The tubular handgrip 45 is disposed to render the manual operation more convenient.

Moreover, with the front and rear piston ring modules 47, 48 in the form of a one-way piston, during the rearward stroke of the tubular piston rod 42, air in the second and third chambers 402, 403 is pre-pressed into and stored in the fourth chamber 404, and during the forward stroke of the tubular piston rod 42, the air in the fourth chamber 404 is pressed into the tubular shaft 43 while air in the first chamber 401 is pre-pressed into the second and third chambers 402, 403. In this manner, the inflating efficiency of the inflating device 200 is further improved.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A hand air pump inflating device comprising:
a nozzle having an inflating conduit formed therein; and
a cylinder mechanism including
a cylinder body extending in a longitudinal direction to terminate at opened front and rear cylinder ends, said front cylinder end being fixed to said nozzle,
a tubular shaft disposed within said cylinder body and extending in the longitudinal direction to terminate at opened front and rear shaft ends, said front shaft end being fixed to said nozzle and in air communication with said inflating conduit,
a tubular piston rod movably disposed within said cylinder body, surrounding said tubular shaft, and extending in the longitudinal direction to terminate at opened front and rear piston ends, such that said tubular piston rod is movable relative to said cylinder body and said tubular shaft in the longitudinal direction to reciprocate a rearward stroke and a forward stroke,
a larger end cap disposed on and enclosing said rear piston end,
a smaller end cap disposed on and enclosing said rear cylinder end and sleeved on and in air-tight and movable engagement with said tubular piston rod,
a front piston ring module disposed on and enclosing said front piston end and having an outer ring portion which is in frictional engagement with said cylinder body to divide a space between said cylinder body and said piston rod into first and second chambers respectively close to said front and rear cylinder ends, and an inner ring portion which is sleeved on and in air-tight and movable engagement with said tubular shaft, such that said front piston ring module is moved with said tubular piston rod to interrupt air communication between said first and second chambers by the rearward stroke, and to permit the air communication between said first and second chambers by the forward stroke,
a rear piston ring module disposed on and enclosing said rear shaft end, and in movable and frictional engagement with said tubular piston rod to divide a space between said tubular piston rod and said tubular shaft into third and fourth chambers respectively close to said front and rear piston ends, such that said rear piston ring module is moved relative to said tubular piston rod to permit air communication between said third and fourth chambers by the rearward stroke, and to interrupt the air communication between said third and fourth chambers by the forward stroke, and
a one-way check valve disposed between said rear shaft end of said tubular shaft and said rear piston ring module to only permit passage of air from said fourth chamber to said tubular shaft,
wherein, during the rearward stroke, a negative pressure is generated in said first chamber as a result of volume increment to introduce air thereinto, and air in said second chamber is pressed into said third chamber and said fourth chamber, and wherein, during the forward stroke, air in said first chamber is pressed to flow into said second chamber and said third chamber, a positive pressure is generated in said fourth chamber as a result of volume decrement to open said check valve, and air in said fourth chamber is pressed to flow into said tubular shaft.

2. The hand air pump inflating device as claimed in claim 1, wherein said cylinder mechanism further includes a tubular handgrip which is securely connected with said larger end cap and which has a grip wall extending forwardly to surround said rear cylinder end of said cylinder body.

3. The hand air pump inflating device as claimed in claim 1, wherein said rear piston ring module includes
a rear piston ring body which is securely connected with said rear shaft end of said tubular shaft and which has an axial hole in air communication with said fourth chamber and said tubular shaft, and which further has an outer annular groove formed in an outer surrounding surface thereof, and a notched passage extending in the longitudinal direction to be in air communication with said outer annular groove and said fourth chamber, and
a movable seal ring which is received in said outer annular groove and which is in air-tight abutment against said tubular piston rod such that said movable seal ring is moved relative to said tubular piston rod during the rearward stroke to permit air communication between said third chamber and said fourth chamber through said outer annular groove and said notched passage, and during the forward stroke to interrupt the air communication between said third and fourth chambers.

4. The hand air pump inflating device as claimed in claim 3, wherein said check valve includes a valve seat which is formed in an end of said axial hole, a valve disc which is movably disposed between said valve seat and said rear shaft end of said tubular shaft in the longitudinal direction, and an annular valve housing which is securely connected with said rear shaft end of said tubular shaft and at a side of said valve disc opposite to said valve seat for receiving said valve disc and limiting a forward movement of said valve disc.

5. The hand air pump inflating device as claimed in claim 1, wherein said front piston ring module includes
a front piston ring body which is securely connected with said front piston end of said tubular piston rod, and which has an outer annular groove formed in an outer surrounding surface thereof, and a notched passage extending in the longitudinal direction to be in air communication with said outer annular groove and said second chamber,
a fixed seal ring which is securely disposed on an inner surrounding surface of said front piston ring body to serve as said inner ring portion, and
a movable seal ring which is received in said outer annular groove to serve as said outer ring portion, such that said movable seal ring is moved relative to said cylinder body during the forward stroke to permit air communication between said first chamber and said second chamber through said outer annular groove and said notched passage, and during the rearward stroke to interrupt the air communication between said first and second chambers.

6. The hand air pump inflating device as claimed in claim 1, wherein said front cylinder end of said cylinder body is securely connected with said nozzle to cooperatively define an intake slot which is in air communication with said first chamber and ambient air, said tubular piston rod having an aperture which is formed at said front piston end and extends radially to be in air communication with said second chamber and said third chamber.

7. The hand air pump inflating device as claimed in claim 6, wherein said nozzle has a cylinder coupling portion which is securely coupled with said front cylinder end of said cylinder body and which has said inflating conduit formed therethrough and extending in the longitudinal direction, and an object coupling portion which is coupled with an inflatable object and which has an inflating port in air communication with said inflating conduit.
